(19) United States
(12) Patent Application Publication
(10) Pub. No.: US 2009/0321694 A1
(43) Pub. Date: Dec. 31, 2009

(54) Optical 3D memory comprising multilayer particles that comprise a photoactive monomer bearing a photoisomerizable group

(75) Inventors: Christophe Le Crom, Jurancon (FR); Ludwik Leibler, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Arkema France, Colombes (FR)

(21) Appl. No.: 12/514,776

(22) PCT Filed: Nov. 26, 2007
(86) PCT No.: PCT/FR2007/052394

§ 371 Date: Aug. 21, 2009

(30) Foreign Application Priority Data
Nov. 28, 2006 (FR) 06.55149

(51) Int. Cl. G02F 1/361

(52) U.S. Cl. 252/586; 252/582

(57) ABSTRACT

The invention relates to a core-shell-type multilayer particle comprising at least one layer B that comprises at least one photoactive monomer bearing a photoisomerizable chromophore and a rigid shell A. The photoactive monomer has the following formula (I): (I) in which: X denotes H or CH₃—; G denotes ═O—C(═O)—, —C(═O)—O—, a substituted or unsubstituted phenyl group, or else —NR—C(═O)—, NR being bonded to L and R being H or a C₁-C₁₀ alkyl group; L denotes a spacer group; CR denotes a photoisomerizable chromophore. It is possible to use the multilayer particle of the invention to achieve optical storage of 2D data.

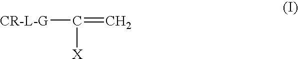

### FIELD OF THE INVENTION

The considerable development of digital information systems has led to a growing need to provide data storage units of large capacity, that are compact and that ensure the preservation of data over a long period which may exceed 50 years. Optical storage is one of the technologies that is available for storing data (see, in connection with this, SPIE “Conference on nano- and micro-optics for information systems” Aug. 4, 2003, paper 5225-16).

The technology that is envisaged in the present invention is more particularly that of 3-dimensional (3D) optical storage, as is disclosed in the international Applications WO 01/73 779 and WO 03/070 689 and also in the Japanese Journal of Applied Physics, Vol. 45, No 28, 2006, pp. 1229-1234. It relies on the use of a photoisomerizable chromophore that is in two thermodynamically stable isomeric forms that are interconvertible under the effect of a light radiation of suitable wavelength. When no data has yet been recorded, one of the two forms is predominant. For writing data, the conversion of this isomeric form to the other one is brought about by light radiation having a suitable wavelength. The conversion may be the result of a direct or indirect optical interaction (for example a multiphoton interaction).

The present invention relates to multilayer particles that make it possible to carry out 3D optical data storage. It also relates to the optical data storage unit, especially in disk form, which comprises multilayer particles.

In Application WO 03/070 689, the chromophores are attached to a polymer by the (co)polymerization of monomers containing said chromophores. Application WO 2006/075 327 points out, in addition, the interest in increasing the chromophore concentration so as to improve the recording sensitivity of the optical memory device. However, when the concentration of the chromophore-containing monomers increases, the mechanical properties of the polymer are affected and the material obtained is either too fragile or too soft to be able to be easily handled. The need exists therefore to develop a rigid material that can be used in the field of 3D optical storage having good data writing and reading abilities.

### BACKGROUND

The Applicant has observed that a material made up of multilayer particles as defined in Claim 1 or of a blend as defined in claim 27 allows the problems posed to be resolved U.S. Pat. No. 5,023,859 discloses an optical memory device based on the use of a polymer containing a photosensitive group of stilbene, spiropyran, azobenzene, bisazobenzene, trisazobenzene or azoxybenzene type. The polymer may be a block polymer but there is nothing further specified about the exact nature of this block polymer.

International Application WO 01/73 779 discloses an optical storage unit in which the information is stored due to the cis-trans transition of a molecule (chromophore) having a C═C double bond. The molecule may especially be a diarylalkylene of formula Ar₁R₁C═CR₂Ar₂ which may be bonded to a polymer.

International Application WO 03/070 689 discloses a polymer containing a diarylalkylene type chromophore. The polymer may be a poly(alkyl acrylate) or a poly(alkyl acrylate) copolymer, especially a copolymer with styrene. It may also be polymethyl methacrylate. It is not specified whether it could be a core-shell particle.

International Application WO 2006/075 328 discloses diarylalkylene type compounds that may be able to be used in optical storage.

International Application WO 2006/075 327 discloses polymers having diarylalkylene type chromophores. Mention is made of a cooperative effect when the chromophore concentration increases. As claimed in one of its forms, the polymer is in the form of nanoparticles, consisting of a crosslinked MMA/eMMA copolymer, dispersed in PMMA, but they are not core-shell particles.

International Application WO 2006/075 328 discloses diarylalkylene type compounds that may be able to be used in optical storage.

International Application WO 2006/075 329 discloses a 3D memory in the form of a disk.

### SUMMARY OF THE INVENTION

The invention relates to a core-shell type multilayer particle comprising at least one layer B comprising at least one photoactive monomer containing a photoisomerizable chromophore and a rigid shell A, the photoactive monomer having the particular formula (1).

The invention also relates to the blend comprising the multilayer particles and a polymer which is a thermoplastic, a thermoplastic elastomer or a thermosetting polymer and to an optical 3D memory device comprising the multilayer particles. The multilayer particle of the invention or the blend of particles and thermoplastic polymer may be used to carry out optical data storage.

### DETAILED DESCRIPTION OF PREFERRED EMBODIMENTS

T_{g} denotes the glass transition temperature of a polymer measured by DSC according to ASTM E1356. The T_{g} of a monomer is also mentioned, which denotes the T_{g} of the homopolymer having a number-average molecular weight Mₙ of at least 10 000 g/mol, obtained by radical polymerization of said monomer. Thus, it can be said that ethyl acrylate has a T_{g} of −24° C. since the poly(ethyl acrylate) homopolymer has a T_{g} of −24° C. All the percentages are given by weight, except where otherwise mentioned.

The term “photoactive monomer”, is understood to mean a monomer containing a photoisomerizable chromophore group CR. The chromophore exists in two isomeric forms, for example, cis-trans. The conversion from one form to the other is carried out under the action of a light radiation of suitable wavelength.

According to the invention, the photoactive monomer has the formula (I):

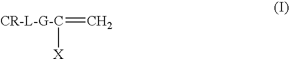

in which:
X denotes H or CH₃—;
G denotes —O—C(═O)—, —C(═O)—O—, a substituted or unsubstituted phenyl group, or else —NR—C(═O)—, NR being linked to L and R being H or a C₁-C₁₀ alkyl group;
L denotes a spacer group; and
CR denotes a photoisomerizable chromophore.

The spacer group L has the role of drawing the chromophore away from the copolymer chain so as to promote the interconversion of the chromophore. This improves the reading capacity and speed. Preferably, L is chosen so that G and CR are linked together by a chain of 2 atoms or more that are linked together by covalent bonds. L may be chosen, for example, from the (CR₁R₂)ₘ, O(CR₁R₂)ₘ and (OCR₁R₂)ₘ groups in which m is an integer higher than 2, preferably between 2 and 10, R₁ and R₂ independently denote H, halogen or alkyl or aryl groups. Preferably, R₁ and R₂ denote H.

The chromophore CR is preferably of the diarylalkylene type existing in the cis and trans isomeric forms. It may be one of the chromophores disclosed in the Applications WO 01/73 779, WO 03/070 689, WO 2006/075 329 or WO 2006/075 327. Preferably, the chromophore CR is chosen so that the energy barrier to the isomerization is above 80 kJ/mol. In fact, it is desirable that the isomerization be a very slow process at room temperature to prevent a loss of recorded data.

Preferably, the photoactive monomer has the formula (II):

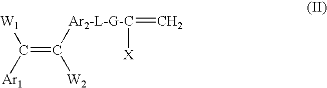

in which:
Ar₁ and Ar₂ denote aryl groups that are possibly substituted; and
W₁ and W₂ are chosen from the groups CN, —COOH, —COOR′, —OH, —SO₂R′ and —NO₂, R′ being a C₁-C₁₀ aryl or linear or branched alkyl group.

The chromophore corresponds to the group Ar₁W₁C═CW₂Ar₂. L is linked by covalent bonds to Ar₂ and also to G. Ar₁ and Ar₂ denote substituted or unsubstituted aryl groups. They are chosen, for example, independently of one another, from phenyl, anthracene or phenanthrene groups. The possible substituent(s) are chosen from: H, linear or branched C₁-C₁₀ alkyl, NO₂, C₁-C₁₀ alkoxy or halogen, NR″R′″ with R″ and R′″ being H or a linear or branched C₁-C₁₀ alkyl. Ar₁ is attached to the C═C double bond of the chromophore. Ar₂ is attached to the C═C double bond of the chromophore and also to the group L.

Preferably, G is —O—C(═O)— or the C₆H₄ phenyl group, that is to say that the monomer has the formula:

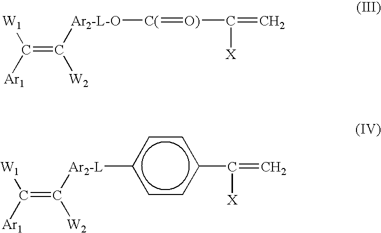

Preferably, Ar₁ is a phenyl group and Ar₂ is a phenyl or biphenyl group, each of the phenyl and/or biphenyl groups may possibly be substituted, that is to say that the chromophore has the formula (V) or (VI):

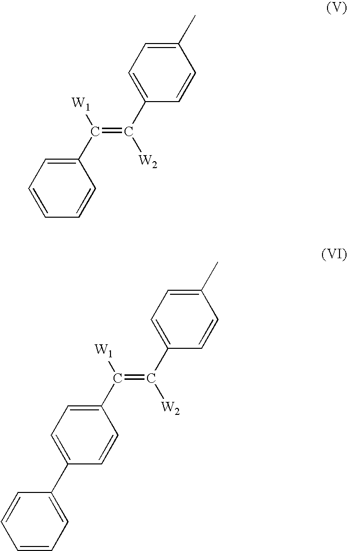

The possible substituents may be, for example, H, aryl, linear or branched C₁-C₁₀ alkyl, NO₂, linear or branched C₁-C₁₀ alkoxy or halogen.

According to a preferred form, W₁ and W₂ denote CN, Ar₂ is a phenyl group, Ar₁ is a phenyl group substituted in the para position by R₅O—. R₅ denotes a substituted or unsubstituted alkyl or aryl group. Preferably, R₅ is a linear or branched C₁-C₄ alkyl group. R₅ may be, for example, a methyl, ethyl, propyl or butyl group. For example, it could be a chromophore of formula (VII):

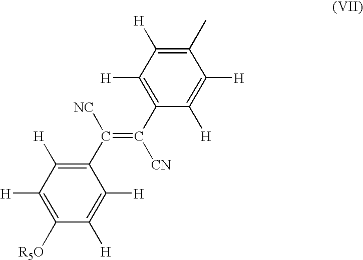

According to another preferred form, W₁ and W₂ denote CN, Ar₂ is a phenyl group, Ar₁ is a biphenyl group substituted in the para position by R₅O—. For example, it could be a chromophore of formula (VIII):

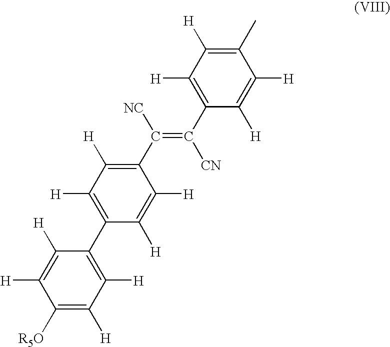

The two monomers below marked eAA and eMMA are more particularly preferred:

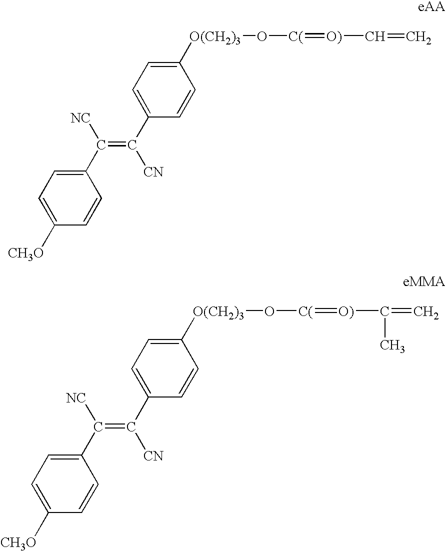

In fact, they have good optical characteristics for writing and reading (see, in connection with this, Japan Journal of Applied Physics Vol. 45, No 28, 2006, pp. 1229-1234)
the trans isomer has a greater fluorescence than the cis;
the trans isomer has a large effective two-photon absorption cross section;
the Stokes shift is greater than 100 nm (little overlap between the absorption spectrum and the emission spectrum with peaks respectively at 375 and 485 nm).

Furthermore, they can be easily copolymerized with a wide range of monomers, in particular by the controlled radical polymerization technique. Finally, they have good stability as the energy barrier to the isomerization is above 80 kJ/mol.

The chromophores that have a small overlap, i.e. <35%, or better still <20%, between the absorption and emission spectra are preferred (see in this regard page 22 of WO 2006/075 327). This makes it possible to increase the chromophore concentration and therefore to promote the cooperative effect without spoiling the signal quality during reading. The overlap depends both on the Stokes shift and on the width of the peak. The overlap is defined as being the percentage of emission which is absorbed per 0.01 M chromophore solution in a 1 cm optical path length cuvette. Preferably, the Stokes shift is >100 nm.

The invention is not limited to particular diarylalkylene type chromophores, but may also be applied to other photoisomerizable chromophores, consisting of, for example, stilbene, spiropyran, azobenzene, bisazobenzene, trisazobenzene or azoxybenzene groups. A list of these chromophores will be found in the following documents U.S. Pat. No. 5,023,859, U.S. Pat. No. 6,875,833 and U.S. Pat. No. 6,641,889.

The term “monomer having a cooperative effect” is understood to mean, a compound of formula (IX):

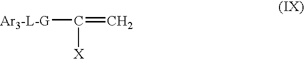

in which:
X, G and L have the same meanings as for the photoactive monomer; and
Ar₃ denotes an aromatic group substituted by at least one substituent having an inductive effect (—I).

This monomer interacts via a cooperative effect with the chromophore and/or improves the cooperative effect between the chromophores themselves, which improves the writing rate. One interpretation of the cooperative effect is that the monomer modifies the microenvironment of the chromophore and promotes the photoisomerization.

The substituent having an inductive effect (—I) is chosen from:
(i) halogens;
(ii) —COOY, —CONYY′, —OY, —SY or —C(═O)Y, Y and Y′ denoting a H or linear or branched C₁-C₁₀ alkyl group.

Advantageously, Ar₃ is a phenyl group. Advantageously, the halogen group is chlorine. Still more advantageously, Ar₃ is chosen from the following groups:

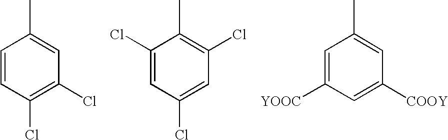

By way of example, the following hindered monomers could be used:

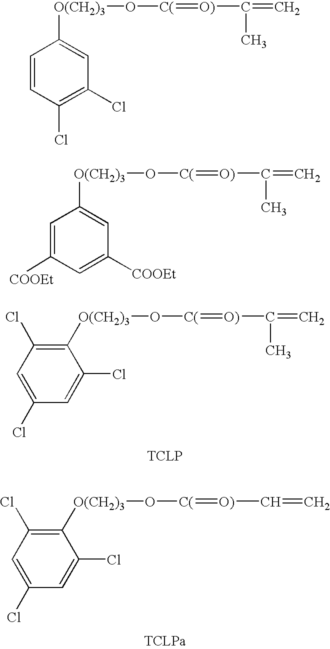

TCLP and TCLPa respectively denote 2,4,6-trichlorophenyl methacrylate and 2,4,6-trichlorophenoxypropyl acrylate.

Regarding the rigid shell A, this consists of a polymer having a T_{g}>0° C., advantageously >60° C., preferably >80° C.

The rigid shell is obtained from the polymerization of at least one vinyl, vinylidene, diene, olefin, allyl or (meth)acrylic monomer. This monomer is chosen more particularly from vinylaromatic monomers such as styrene or substituted styrenes, especially alpha-methylstyrene, acrylic monomers such as acrylic acid or its salts, alkyl, cycloalkyl or aryl acrylates such as methyl acrylate, ethyl acrylate, butyl acrylate, ethylhexyl acrylate or phenyl acrylate, hydroxyalkyl acrylates such as 2-hydroxyethyl acrylate, etheralkyl acrylates such as 2-methoxyethyl acrylate, alkoxy- or aryloxy-poly(alkylene glycol) acrylates such as methoxypoly(ethylene glycol) acrylates, ethoxypoly(ethylene glycol) acrylates, methoxypoly(propylene glycol) acrylates, methoxypoly(ethylene glycol)-poly(propylene glycol) acrylates or their mixtures, aminoalkyl acrylates such as 2-(dimethylamino)ethyl acrylate (DMAEA), fluoro acrylates, silyl acrylates, phosphorus acrylates such as alkylene glycol phosphate acrylates, methacrylic monomers such as methacrylic acid or its salts, alkyl, cycloalkyl, alkenyl or aryl methacrylates, such as methyl methacrylate (MMA), lauryl methacrylate, cyclohexyl methacrylate, allyl methacrylate, phenyl methacrylate or naphthyl methacrylate, hydroxyalkyl methacrylates such as 2-hydroxyethyl methacrylate or 2-hydroxypropyl methacrylate, etheralkyl methacrylates such as 2-ethoxyethyl methacrylate, alkoxy- or aryloxy-poly(alkylene glycol) methacrylates such as methoxypoly(ethylene glycol) methacrylates, ethoxypoly(ethylene glycol) methacrylates, methoxypoly(propylene glycol) methacrylates, methoxypoly(ethylene glycol)-poly(propylene glycol) methacrylates or their mixtures, aminoalkyl methacrylates such as 2-(dimethylamino)ethyl methacrylate (DMAEMA), fluoro methacrylates such as 2,2,2-trifluoroethyl methacrylate, silyl methacrylates such as 3-methacryloylpropyltrimethylsilane, phosphorus methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethyl ammonium chloride (MAPTAC), itaconic acid, maleic acid or its salts, maleic anhydride, alkyl or alkoxy- or aryloxy-poly(alkylene glycol) maleates or hemimaleates, vinylpyridine, vinylpyrrolidinone, (alkoxy) poly(alkylene glycol) vinyl ether or divinyl ether, such as methoxy poly(ethylene glycol) vinyl ether, poly(ethylene glycol) divinyl ether, olefin monomers, among which mention may be made of ethylene, butane, hexene and 1-octene and also fluoro olefin monomers, and vinylidene monomers, among which mention may be made of vinylidene fluoride, these monomers being used alone or as a mixture of at least two aforesaid monomers.

The rigid shell is obtained preferably from styrene and/or from (meth)acrylic monomer(s). Advantageously, it comprises styrene and/or MMA as the main monomer(s). Preferably, it comprises from 80 to 100% of styrene and/or MMA.

Regarding the layer B, this comprises at least one photoactive monomer and possibly at least one other monomer that can be copolymerized with the photoactive monomer. The other monomer may be chosen from the previously defined list of monomers. It may also be a hindered monomer. The content of photoactive monomer in layer B may range from 5 to 100 wt %.

According to a preferred form, the monomer that is copolymerized with the photoactive monomer is a monomer having a cooperative effect. It is preferably TCLP or TCLPa. The layer B therefore comprises 10 to 80 wt % of at least one photoactive monomer, 10 to 80 wt % of at least one monomer having a cooperative effect and possibly one monomer from the previous list (the total making 100 wt %). Butyl acrylate or methyl methacrylate may advantageously be used as comonomer of the photoactive monomer and the monomer having a cooperative effect.

Regarding the multilayer particle of the invention, it is a core-shell type particle that comprises at least one layer B and one rigid shell A (constituting the outer layer). One of the purposes of the rigid shell and A is to rigidify the multilayer particle and to obtain, after conversion, a sufficient rigidity and mechanical strength for the material. One of the purposes of the layer B is to store the data. The multilayer particle typically has an average diameter ranging from 10 to 1000 nm. In addition, the layer B/shell A mass ratio preferably ranges from 90/10 to 10/90.

The multilayer particle is prepared by an aqueous-emulsion process in which each layer is prepared by successive monomer polymerization steps in the presence of at least one surfactant and at least one radical initiator. It will be possible to refer to the following work for the description of core-shells: “Les latex synthétiques” (Synthetic latices), by E. Raynaud, Tec & Doc, ISBN 2743008202, and also to “Emulsion polymerization, theory and practice”, D. C. Backley, ISBN 0-85334-627-5, Applied Science Publisher Ltd. 1975 for more details on the emulsion. At the end of the emulsion process, multilayer particles are recovered in powder form, for example by a spraying step.

The multilayer particle may comprise one or more other layer(s) in addition to the rigid shell and the layer B. For example it may comprise, placed one against another (in the order from the inside towards the outside of the particle), an inner layer (the core), a layer B and a rigid shell. It may also comprise, placed one against another (in the order from the inside towards the outside of the particle), an inner layer B (the core), an intermediate layer and a rigid shell. The multilayer particle preferably comprises only two layers, a layer B constituting the core of the particle and placed against the layer B, a rigid outer shell.

Each layer may possibly be crosslinked. The crosslinking allows all or part of the initial shape of the particle to be kept. In order to do this the polymerization leading to the crosslinked layer is carried out in the presence of at least one crosslinking agent, that is to say a compound that has at least two groups that can be polymerized. It may be, for example, a diacrylate, a triacrylate or divinylbenzene. Each layer may also possibly comprise a monomer that facilitates the adhesion of said layer with the other layer(s) with which it is in contact. For example, this monomer may be a diacrylate or an allyl monomer.

The multilayer particles may be used alone or else in a blend with another polymer that has sufficient transparency in the wavelength region used for writing or reading and also a low birefringence. It may be a thermoplastic, a thermoplastic elastomer or a thermoset. This characteristic is important for 3D optical memory technology for which it is necessary that the light ray reaches each of the memory layers without being disturbed. Preferably a thermoplastic such as a homo- or copolymer of methyl methacrylate (MMA), of styrene or else a polycarbonate, is used. The blend comprises 50 to 100 wt %, advantageously 75 to 100 wt %, preferably 90 to 100 wt %, of the multilayer particles respectively per 0 to 50 wt %, advantageously 0 to 25 wt %, preferably 5 to 10 wt % of the thermoplastic or of the thermoset. The blend is produced using any of the techniques for blending thermoplastics that are known to those skilled in the art. Preferably extrusion is used. The blend may also optionally comprise various additives (antistatic, lubricant, dye, plasticizer, antioxidant, UV stabilizer, etc).

### Writing/Reading of Data

The optical principles which underlies the present invention are the same as those described in International Applications WO 01/73779 and WO 03/070689 which have already been published. Writing relies on the conversion from one isomeric form to another under the effect of light radiation. The conversion necessitates having a chromophore in an exited state, which necessitates absorption at an energy level E. The absorption of two photons is facilitated by combining the energy of at least two photons of one or more light beams which have energy levels E₁ and E₂ which may be different from E. The two light beams are in the UV, visible, or near infrared region. Preferably, only one light beam is used and the conversion is the result of a two-photon absorption process.

Reading may rely on a linear or non-linear electronic excitation process. The emission spectra of the two isomers are different and the emission is collected using an appropriate reading device. A non-linear process such as Raman dispersion or a four wave mixing process may be used.

A small volume portion of the 3D memory contains chromophores predominantly in one isomeric form or else in the other. The volume portion contains therefore information stored in a well defined and localized zone in the memory device and is characterized by an optical signal which is different from that of its immediate vicinity.

### Regarding 3D Optical Memory

The invention also relates to the 3D optical memory device (or 3D optical storage unit) comprising the multilayer particles or the blend of the invention and which is used to record (store) data. A 3D memory device is a memory device that allows data to be stored at any point of the memory device (defined by three coordinates x, y and z) of the volume. A 3D memory device allows the data to be stored in several virtual layers (or virtual levels). The volume of the 3D memory device is therefore linked to the physical volume occupied by said device.

This memory device is, for example, in the form of a square or rectangular plate, a cube or else a disk which comprises the multilayer particles of the invention, possibly in the form of a blend as was described.

Preferably, the optical storage unit is in disk form which allows it to be rotated, the writing or reading head thus being stationary. The disk may be produced by moulding of the multilayer particles or of the blend. It may also be produced by deposition of the multilayer particles or of the blend on a rigid and transparent support in the wavelength region used for writing and/or reading.

It is possible to obtain the 3D memory device by the injection-molding technique. This conversion technique is known by plastics processors and consists in injecting, under pressure, the molten material into a mold (in this regard reference could be made to “Précis de matières plastiques” [Plastics Handbook], Nathan, 4th edition, ISBN 2-12-355352-2, pp. 141-156). The material is melted and compressed using an extruder (when the multilayer particles are in powder form it is necessary to convert them, in a prior step, into granules, for example using an extrusion-granulation operation). It is also possible to superpose several layers comprising the block copolymer or the blend of the invention as taught in International Application WO 2006/075 329.

Preferably, the 3D optical memory device is in disk form, which allows it to be rotated, the writing or reading head being essentially stationary. The disk may be produced by injection-molding or molding of the block copolymer or of the blend if it has suitable mechanical characteristics. It may also be produced by deposition of the block copolymer or the blend on a rigid and transparent support in the wavelength region used for writing and/or reading.

### EXAMPLES

### Example 1

### Preparation of Core-Shell Particles

### Preparation of the Core

Introduced into a 500 ml glass reactor with stirring were 100 g of water, 0.6 g of sodium lauryl sulphate, 0.075 g of Na₂HPO₄, 6.75 g of eMMA, 6.75 g of TCLP and 1.5 g of butyl acrylate and 0.003 g of allyl methacrylate. The mixture was heated to 95° C. for 30 minutes, then an aqueous solution of 0.12 g of potassium persulphate in 18 g of water was introduced continuously over 3 hours. Next, 0.015 g of potassium persulphate was introduced and it was left stirring for 1 hour at 95° C.

The core had the following characteristics:

number-average molecular weight: 61 970 g/mol
weight-average molecular weight: 714 950 g/mol
polydispersity: 11.54

### Preparation of the Shell

Added continuously over 1 hour to the previous mixture with stirring at 95° C. were 6.43 g of styrene continuously over 1 hour and an aqueous solution of 0.00643 g of potassium persulfate in 5 g water. It was left at 95° C., with stirring, for 1 hour.

The core-shell particles had the following characteristics:

number-average molecular weight: 18 650 g/mol
weight-average molecular weight: 182 090 g/mol
polydispersity: 9.77
particle size: 60 nm

These particles were then coagulated at low temperature (−25° C.). The product obtained was filtered, washed and dried. The product was then shaped by compression-molding at 150° C. for 10 min in order to form a disk having a diameter of 2 cm and a thickness of 2 mm. The light transmission was greater than 90% over the entire visible range.

This disk was then subjected to a static data reading-writing test using an appropriate laser device. Recording of the data onto the disk was observed.

### Examples 2 to 3

The procedure from example 1 was followed except for the ratio between the core and the shell and the amount of crosslinking agent introduced into the core. For example 2, the core/shell ratio was 50/50 and for example 3 the core was crosslinked with 1% polyethylene glycol diacrylate having a molecular weight of 600 g. The disk obtained for examples 2 and 3 enabled data to be recorded in a comparable manner to that of example 1.

1-33. (canceled)

34. A multilayer particle comprising at least one layer B comprising at least one photoactive monomer comprising a photoisomerizable chromophore and a rigid shell A, the photoactive monomer having the formula (I): 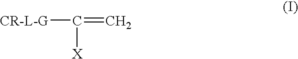
wherein:
X denotes H or CH₃—;
G denotes —O—C(═O)—, —C(═O)—O—, a substituted or unsubstituted phenyl group, or —NR—C(═O)—, wherein NR is linked to L and R is H or a linear or branched C₁-C₁₀ alkyl group;
L denotes a spacer group; and
CR denotes a photoisomerizable chromophore.

35. The multilayer particle of claim 34, wherein the layer B comprises the core of the particle and is placed against a rigid outer shell A.

36. The multilayer particle of claim 34, comprising, in addition to the layer B and the rigid shell A, one or more additional layer(s).

37. The multilayer particle of claim 34, comprising an inner layer B, an intermediate layer, and a rigid outer layer,
wherein said layers are arranged one against the other.

38. The multilayer particle of claim 34, wherein at least one of layer B or rigid shell A is crosslinked.

39. The multilayer particle of claim 37, wherein at least one of layer B, the intermediate layer, or rigid shell A is crosslinked.

40. The multilayer particle of claim 34, wherein the rigid shell A comprises a polymer having a T_{g}>0° C.

41. The multilayer particle of claim 40, wherein the rigid shell A comprises a polymer having a T_{g}>60° C.

42. The multilayer particle of claim 40, wherein the rigid shell A comprises a polymer having a T_{g}>80° C.

43. The multilayer particle of claim 34, wherein the rigid shell A comprises styrene and/or MMA as the main monomer(s).

44. The multilayer particle of claim 43, wherein the rigid shell A comprises from 80 to 100% of styrene and/or MMA.

45. The multilayer particle of claim 34, wherein the layer B/shell A mass ratio ranges from 90/10 to 10/90.

46. The multilayer particle of claim 34, wherein the spacer group L is chosen so that G and CR are linked together by a chain of two or more atoms that are bonded together by covalent bonds.

47. The multilayer particle of claim 34, wherein L comprises (CR₁R₂)ₘ, O(CR₁R₂)ₘ, or (OCR₁R₂)ₘ,
wherein m is an integer greater than or equal to 2, and R₁ and R₂ independently denote H, halogen, or linear or branched alkyl or aryl groups.

48. The multilayer particle of claim 46, wherein m is an integer ranging from 2 to 10.

49. The multilayer particle of claim 34, wherein the chromophore CR is of diarylalkylene type.

50. The multilayer particle of claim 34, wherein the chromophore CR has an overlap of <35% when spectra are recorded on a 0.01 M chromophore solution in a 1 cm optical path length cuvette.

51. The multilayer particle of claim 34, wherein the Stokes shift of the chromophore CR is greater than 100 nm.

52. The multilayer particle of claim 34, wherein the photoactive monomer has the formula (II): 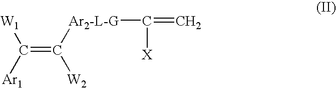
wherein:
Ar₁ and Ar₂ denote aryl groups that are optionally substituted; and
W₁ and W₂ comprise the groups —CN, —COOH, —COOR′, —OH, —SO₂R′, or —NO₂,
wherein R′ is a C₁-C₁₀ aryl or linear or branched alkyl group.

53. The multilayer particle of claim 52, wherein Ar₁ and Ar₂ independently comprise phenyl, anthracene, or phenanthrene groups.

54. The multilayer particle of claim 51, wherein the photoactive monomer has the formula (III) or (IV): 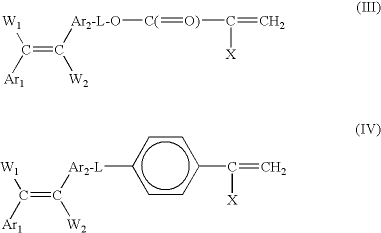
wherein:
Ar₁ and Ar₂ denote aryl groups that are optionally substituted; and
W₁ and W₂ comprise the groups —CN, —COOH, —COOR′, —OH, —SO₂R′, or —NO₂,
wherein R′ is a C₁-C₁₀ aryl or linear or branched alkyl group.

55. The multilayer particle of claim 34, wherein the chromophore comprises: 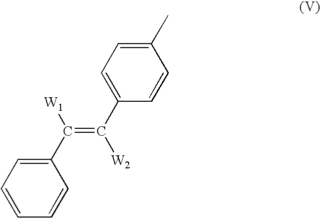
wherein:
W₁ and W₂ comprise the groups —CN, —COOH, —COOR′, —OH, —SO₂R′ and —NO₂, wherein R′ is a C₁-C₁₀ aryl or linear or branched alkyl group, and each of the two phenyl rings are optionally substituted.

56. The multilayer particle of claim 53, wherein Ar₁ is a phenyl group and Ar₂ is a phenyl or biphenyl group, wherein each of the phenyl and/or biphenyl groups are optionally substituted.

57. The multilayer particle of claim 56, wherein W₁ and W₂ denote CN, Ar₂ is a phenyl group, and Ar₁ is a phenyl or biphenyl group substituted in the para position by R₅O—, wherein R₅ denotes a substituted or unsubstituted, linear or branched alkyl or aryl group.

58. The multilayer particle of claim 45, wherein the photoactive monomer is eAA or eMMA of formulae:

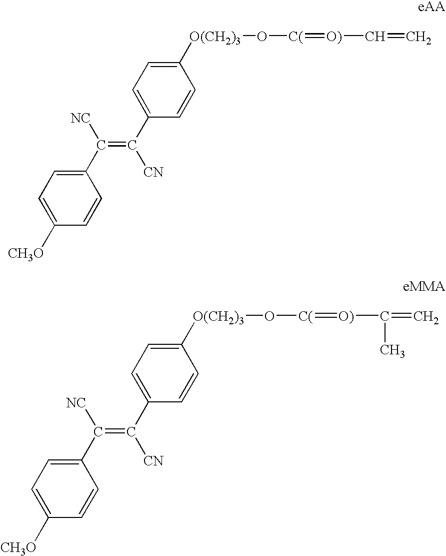

59. The multilayer particle of claim 34, wherein the layer B comprises a monomer that can be copolymerized with a photoactive monomer having a T_{g}<0° C.

60. The multilayer particle of claim 34, wherein the layer B comprises a monomer having a cooperative effect of formula (IX): 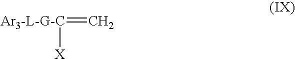
wherein:
X denotes H or CH₃—;
G denotes —O—C(═O)—, —C(═O)—O—, a substituted or unsubstituted phenyl group, or —NR—C(═O)—, wherein NR is linked to L and R is H or a linear or branched C₁-C₁₀ alkyl group;
L denotes a spacer group; and
Ar₃ denotes an aromatic group substituted by at least one substituent having an inductive effect (—I).

61. The multilayer particle of claim 60, wherein the substituent having an inductive effect (—I) comprises:
(i) a halogen or
(ii) —COOY, —CONYY′, —OY, —SY, or —C(═O)Y,
wherein Y and Y′ denote an H or a linear or branched C₁-C₁₀ alkyl group.

62. The multilayer particle of claim 61, wherein said halogen is chlorine.

63. The multilayer particle of claim 60, wherein Ar₃ is a phenyl group.

64. The multilayer particle of claim 60, wherein the monomer having a cooperative effect comprises:

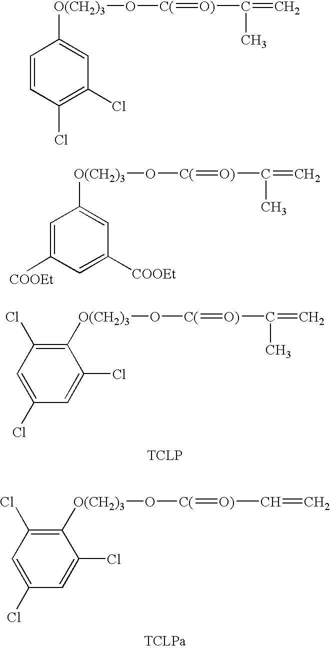

65. A blend comprising the multilayer particle of claim 34 and a thermoplastic or thermosetting polymer.

66. The blend of claim 65 wherein said thermoplastic is an elastomer.

67. The blend of claim 65 comprising from 50 to 100 wt % of the multilayer particle per 0 to 50 wt % of the thermoplastic or thermosetting polymer.

68. The blend of claim 65 comprising from 75 to 100 wt % of the multilayer particle per 0 to 25 wt % of the thermoplastic or thermosetting polymer.

69. The blend of claim 65 comprising from 90 to 100 wt % of the multilayer particle per 5 to 10 wt % of the thermoplastic or thermosetting polymer.

70. The blend of claim 65, wherein the thermoplastic polymer is a homo- or copolymer of methyl methacrylate or a polycarbonate.

71. A 3D optical memory device comprising the multilayer particle of claim 34.

72. A 3D optical memory device comprising the blend of claim 65.

73. The 3D optical memory device of claim 71, wherein said 3D optical memory device is in the form of a square or rectangular plate, a cube, or a disk.

74. A method comprising the step of storing optical data on an optical data storage unit comprising the multilayer particle of claim 34.

75. A method comprising the step of storing optical data on an optical data storage unit comprising the blend of claim 65.
